(19) United States
(12) Patent Application Publication
(10) Pub. No.: US 2023/0327764 A1
(43) Pub. Date: Oct. 12, 2023

(54) Host-Based Optical Frequency Tuning

(71) Applicant: Nokia Solutions and Networks Oy, Espoo (FI)

(72) Inventors: Stawros Orkopoulos, Nersingen (DE); Uwe Schmiade, Rammingen (DE)

(21) Appl. No.: 18/131,932

(22) Filed: Apr. 7, 2023

(30) Foreign Application Priority Data
Apr. 11, 2022 (FI) 20225317

(51) Int. Cl. H04B 10/2575

(52) U.S. Cl. CPC H04B 10/25753

(57) ABSTRACT

According to an aspect, there is provided a first apparatus configured to perform the following. The first apparatus transmits a first notification message via a tunable small-form pluggable, SFP, module on a first channel over an optical transport network to a second apparatus by applying on-off keying to an optical transmitter of the SFP module. The first notification message includes information on the first channel. The first apparatus receives a first notification response message via the tunable SFP module from the second apparatus as an on-off keyed transmission on the first channel or a second channel. The first notification response message includes the information on the first channel. The first apparatus evaluates the first notification response message for acquiring the information on the first channel.

### TECHNICAL FIELD

Various embodiments relate to wireless communications.

### BACKGROUND

Optical transport networks (OTN) are commonly used in access nodes for fronthauling, that is, for communication between a centralized radio controller (or centralized baseband unit) of the access node and the remote radio head(s) of the access node. Typically, a small-form pluggable (SFP) module is used, in the centralized radio controller and in the remote radio head(s), for signal conversion from optical signals received via the OTN to electrical signals (and vice versa). The SFP module may also serve to tune the optical frequency (or equally optical wavelength) of signals transmitted over the OTN.

### BRIEF DESCRIPTION

According to an aspect, there is provided the subject matter of the independent claims. Embodiments are defined in the dependent claims.

One or more examples of implementations are set forth in more detail in the accompanying drawings and the description below. Other features will be apparent from the description, drawings and the claims.

### BRIEF DESCRIPTION OF DRAWINGS

In the following, embodiments will be described in greater detail with reference to the attached drawings, in which

FIG. 1 illustrates an exemplified wireless communication system;

FIG. 2 illustrates a system according to embodiments;

FIG. 3 illustrates interface mapping according to embodiments;

FIG. 4 illustrates functional building blocks of an algorithm according to an embodiment;

FIGS. 5A, 5B and 6 illustrate exemplary signaling according to embodiments;

FIG. 7 illustrates a frame format according to an embodiment;

FIGS. 8A and 8B illustrate two examples of clustering of frames according to embodiments; and

FIG. 9 illustrates an apparatus according to embodiments.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), longterm evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

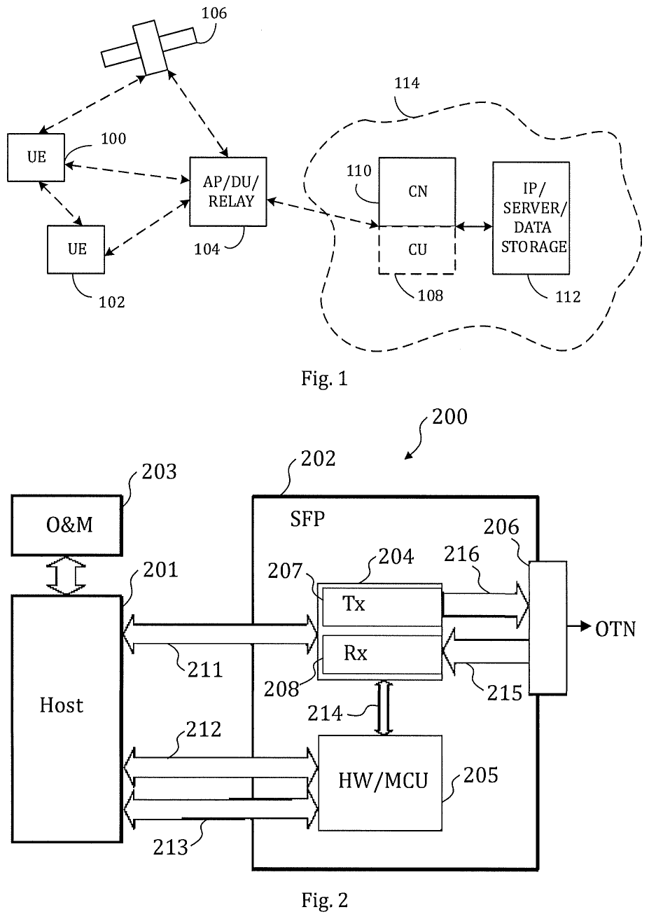

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

As described above, the access node operations may be carried out, at least partly, in a server, host or node operationally coupled to a remote radio head (equally called a radio head or radio unit). Said server, host or node may be called, for example, central or centralized unit, a central or centralized radio controller or a central or centralized baseband unit (BBU). The access node 104 of FIG. 1 may comprise, in general, one or more radio heads and a centralized unit. The (front-haul) communication between the centralized unit and the one or more radio heads may be implemented using an optical transmission medium (e.g., optical fiber). Specifically, optical transport network (OTN) may be employed for forming said communication link. OTN may be defined as a set of optical network elements (ONE) connected by optical fiber links, able to provide functionality of transport, multiplexing, switching, management, supervision and survivability of optical channels carrying client signals.

FIG. 2 illustrates a system 200 (or node) according to an embodiment for enabling communication over OTN. Said system 200 may correspond to or be comprised in a (remote) radio head or a centralized unit of an access node (e.g., an access node 104 of FIG. 1).

The system 200 of FIG. 2 may be connected over the OTN (i.e., over an optical fiber) to another system having the same or similar architecture. Said two systems may be equally called peer nodes or, respectively, near-end and far-end nodes.

Referring to FIG. 2, the system comprises at least a host 201 and a small-form pluggable (SFP) module 202 connected to the host 201. Optionally, the host 201 may further be connected to an Operations and Maintenance (O&M) unit 202, e.g., for support of open radio access network (O-RAN) architecture.

The SFP module 202 (equally called the SFP transceiver) is a compact, hot-pluggable network interface module for carrying out signal conversion from an optical signal to an electrical signal (in reception) and from an electrical signal to an optical signal (in transmission).

The SFP module 202 may operate, at a given time, at particular channel having a particular channel number. Each channel may be associated with a particular optical wavelength (or equally a particular optical frequency). It should, therefore, be noted that the terms “channel” (or “channel number”), “optical wavelength” and “optical frequency” may be used, in many cases, in the context of the embodiments interchangeable as selecting or changing a value for one of the three quantities uniquely defines the values of the other two quantities. The mapping between channel numbers and optical wavelengths may follow an ITU (International Telecommunication Union) standard. This mapping may be assumed to be known to the host 201 as well as to any other host(s) of peer nodes.

The SFP module 202 may be, in particular, a tunable SFP module (TSFP) 202, that is, an SFP module whose (operating) channel/optical wavelength/optical frequency can be changed dynamically.

The SFP module 202 may be plugged into an SFP cage (not shown in FIG. 2). The SFP module may correspond to a “conventional” SFP module or any enhanced next-generation SFP module such as an SFP+ module, an SFP28 module or an SFP56 module.

The SFP module 202 may comprise at least an optical transceiver 204 for carrying out said signal conversion from optical to electrical and vice versa and hardware logic and/or microcontroller 205 for controlling the optical transceiver 204. The microcontroller 205 may optionally also provide some diagnostic features. The optical transceiver 204 and the hardware logic and/or microcontroller 205 are connected to each other via at least one interface 214. The optical transceiver 204 comprises an optical transmitter 207 for performing electrical-to-optical (E/O) conversion in transmission and an optical receiver 208 for performing optical-to-electrical (O/E) conversion in reception. The optical transmitter 207 comprises at least an E/O converter (comprising a transmit laser), and the optical receiver 208 comprises at least an O/E converter (comprising a receiver photo diode). The optical transceiver 204 (i.e., each of the optical transmitter and receiver 207, 208) is connected to a cable or fiber connector 206 of the SFP module 202. The cable or fiber connector 206 enables connecting the SFP module 202 (or specifically the optical transceiver 204 thereof) to an optical cable or fiber of an optical transport network (OTN).

The host 201 may be equally called a computing device, a server or simply an apparatus. The host 201 may comprise one or more separate (computing) devices. The host 201 is configured to execute, in communication with the SFP module 202, a wavelength/channel tuning (or selection) algorithm according to embodiments, as will described in detail in connection with the following Figures.

The host 201 is configured to communicate with the SFP module 202 via the interfaces 211, 212, 213. Namely, the host 201 is connected to the optical transceiver 204 via a first interface 211 and to the hardware logic and/or microcontroller 205 via second and third interfaces 212, 213.

The first interface 211 may be specifically a (serial) high-speed (physical) interface such as a serializer/deserializer (SerDes) interface. The high-speed interface 211 may be used for reception of electrical signals from the optical receiver 208 and transmission of electrical signals to the optical transmitter 207 (for further transmission via the OTN after E/O conversion). The term “high-speed interface” may be defined, here and in the following, as an interface providing a symbol rate of multiple gigabauds.

The second interface 212 may be specifically a (serial) low-speed (physical) interface such as an inter-integrated circuit (I2C) interface. The low-speed interface 212 may be used for accessing internal memory banks of the SFP module 202. The low-speed interface 212 may be used for accessing digital diagnostic and monitoring features of the SFP module 202. The memory allocation and register settings may be standardized. Optionally, some of the registers of the SFP modules 202 may be configurable. The serial clock rate may be up to 100 kHz. The low-speed interface 212 may have a (maximum) symbol (or data) rate lower than the high-speed interface 211.

In some embodiments, the low-speed interface 212 may be a low-speed interface according to MSA (multiple source agreement) SFF-8419 standard.

The third interface 213 may be an interface for connecting to one or more (dedicated) hardware pins of the hardware logic 205. The one or more hardware pins provide access to specific SFP module functions by hardware. For example, one hardware pin may indicate the status of the SFP module 202 while another may be used to change the status, e.g., hardware pin for enabling/disabling laser of the optical transmitter 207 of the SFP module 202.

As mentioned above, the SFP module 202 may be specifically a tunable SFP module (or configurable SFP module). The term “tunable” refers here specifically to tunability of the optical frequency (or equally of the optical wavelength or channel). The optical frequency (or equally optical wavelength) of the transmitted and/or received signals may be configurable (by a user) using the host 201. The configuration of the optical frequency may be achieved, e.g., via a separate management interface (not shown in FIG. 2). The optical frequencies used for transmission or reception may be the same or may be different frequencies (assuming a duplex fiber cable is employed).

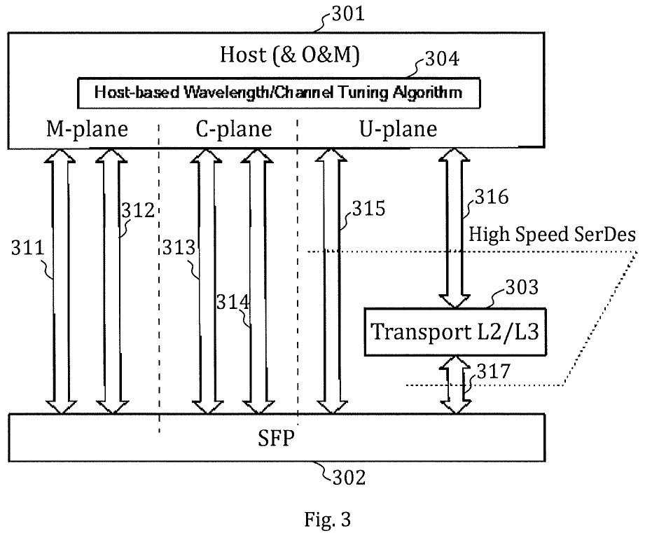

As described in connection with FIG. 2, the frequency (or equally wavelength or channel) tuning functionality according to embodiments requires interfacing between the host 201 and the tunable SFP module 202. FIG. 3 illustrates in further detail mapping of the interfaces of a tunable SFP module 302 to management (M), control (C) and user (U) planes. The system of FIG. 3 may correspond to a more detailed view of some aspects (namely, interfaces) of the system of FIG. 2. Namely, the tunable SFP module 302 (representing physical layer) may correspond to the SFP module 202 of FIG. 2 and the host (or the host/O&M) 301 may correspond to the host 201 of FIG. 2 (or a combination of the host 201 and the O&M entity 203 of FIG. 2).

It should be noted that the interfaces 311 to 317 of FIG. 3 are logical interfaces. Some of the interfaces 311 to 317 may correspond to the same physical interface. Namely, the M-plane interfaces 311, 312 may correspond to the same physical interfaces as the C-plane interfaces 313, 314.

Referring to FIG. 3, the signalling on the M-plane between the host 301 and the SFP 302 is enabled via a first logical interface 311 corresponding to the one or more hardware pins and/or via a second logical interface 312 corresponding to the (serial) low-speed I2C interface 312 (or bus). Any signal/register that is used for state requests may be mapped to the M-plane. Thus, state information of the SFP module 302 may be obtained via the one or more hardware pins 311 and/or the low-speed I2C interface 312. For example, a particular hardware pin of the SFP module 202 may be used for indicating the state of the SFP 202 in hardware while a particular register of the SFP module 202 may be used for indicating the status of the SFP module 202 using I2C/in software.

Similarly, the signalling on the C-plane is also enabled via the one or more hardware pins over the third logical interface 313 and/or via the (serial) low-speed I2C interface over the fourth logical interface 314. As mentioned above, there may be no strict separation between M- and C-planes so that the same low-speed I2C interface and/or the same one or more HW pins are used for both M- & C-plane signaling. Any signal/register that is used for control (i.e., for control requests) may be mapped to the C-plane. Thus, the SFP module 302 may be controlled via the one or more hardware pins and/or the low-speed I2C interface (or bus). For example, a particular hardware pin may be used for keeping a transmit laser of an optical transmitter of the SFP module 302 in an off state in hardware while a particular register may be used for keeping said transmit laser off using I2C/in software.

The signalling on the U-plane is enabled via fifth, sixth and seventh logical interfaces 315 to 317 corresponding to the high-speed interface (being, e.g., a SerDes interface). Three options may exist here:
1) communication over layer 2 (L2),
2) communication over layer 3 (L3) and
3) communication over layer 1 (L1), i.e., without Ethernet stack.
   The options 1) and 2) correspond to elements 303, 316, 317 while the option 3 corresponds to element 315. In some embodiments, at least options 1) and/or 2) may be employed. At least the message frame transfer may be mapped to the U-plane.

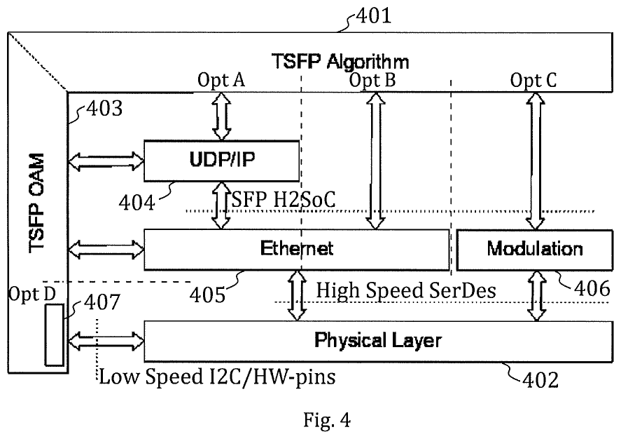

FIG. 4 illustrates functional building blocks associated with the embodiments and their interworking.

In FIG. 4, the physical layer block 402 represents the SFP Module (corresponding, e.g., to the SFP module 202 of FIG. 2 and/or the SFP module 302 of FIG. 3). The SFP module 402 is interfaced to the TSFP O&M function 403 via the I2C and HW-pins. Therefore, the SFP module 402 is (re)configurable. The block 407 corresponds to (low-speed) modulation.

The Ethernet protocol 405 may be used at least for establishing a communication path between peer nodes, i.e., between far-end and near-end nodes.

The User Datagram Protocol (UDP)/Internet Protocol (IP) 404 may provide access to the host via IP addressing and a dedicated UDP port.

The tunable SFP algorithm 401 according to embodiments (to be discussed in detail) enables frequency (or wavelength) tuning functionality for the SFP module 402. This may comprise the frequency (wavelength/channel) detection and configuration.

The TSFP O&M function 403 may be used for configuring the protocol stack and/or the tunable SFP module 402.

The modulation protocol 406 has direct access to the physical layer 402. The TSFP messages are modulated for communication via high-speed and/or low-speed interfaces.

Based on FIG. 4, three different implementation options may be discerned: TSFP algorithm over UDP/IP (option A), TSFP algorithm over Ethernet (option B), TSFP algorithm over high-speed modulation (option C) and finally TSFP algorithm over low-speed modulation (option D). Here, options A, B and C may correspond to the options 2), 1) and 3) defined for U-plane signalling in connection with FIG. 3, respectively.

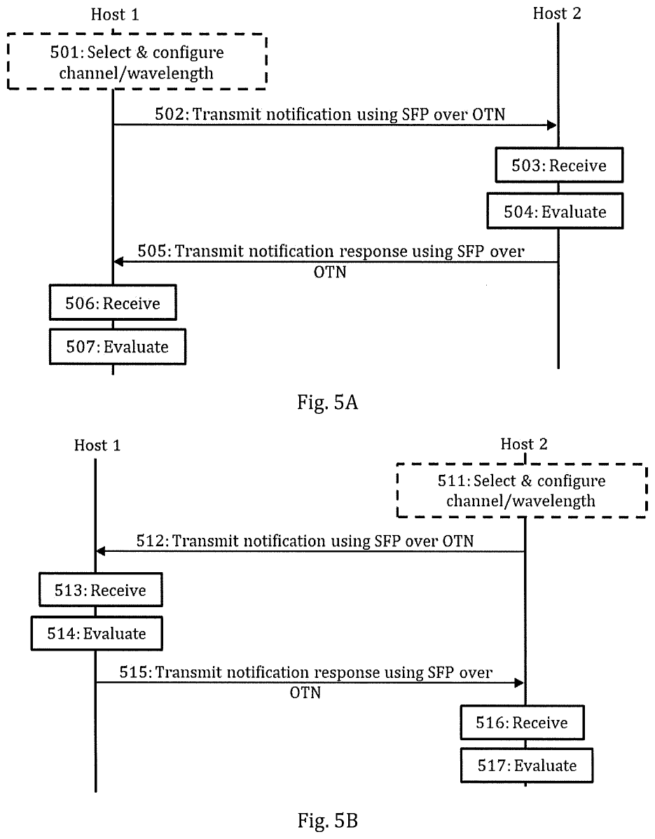

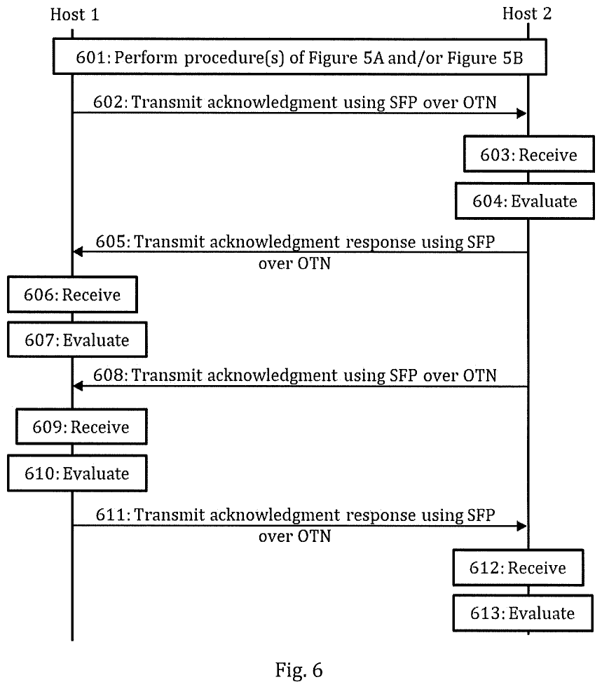

FIG. 5A illustrates signalling between first and second peer nodes over an OTN for channel/wavelength selection. The first and second peer nodes may be assumed to be defined as described in connection with FIGS. 2, 3 and/or 4. Specifically, the actions described in connection with FIG. 5A may be carried out by first and second hosts of the first and second peer nodes in communication with respective first and second tunable SFP modules.

Initially, the first host may select, in block 501, a first channel for transmission via the first tunable SFP module over the OTN (i.e., over an optical fiber). The first channel is associated with (or uses) a first optical wavelength (and equally with a first optical frequency). The selection of the first channel in block 501 may be performed from a plurality of channels supported by the first tunable SFP module, where the plurality of channels may be associated, respectively, with a plurality of (different) optical wavelengths. The first channel has a first channel number (being, e.g., a positive or at least non-negative integer such as 1 or 4). The selection in block 501 may be carried out based on a pre-defined list or lookup table defining said plurality of channels stored in a memory. For example, the first host may select the initial or next channel/wavelength in said list or lookup table.

Moreover, the first host may configure or command, in block 501, the first tunable SFP module to use the first channel (and thus the first optical wavelength) for transmission. The configuring/commanding in block 501 may be carried out, e.g., using a management interface of the tunable SFP module.

The first host (forms and) transmits, in message 502, a first notification message via the first tunable SFP module over the OTN on the first channel to the second host by applying on-off keying to an optical transmitter (or a transmit laser) of the first tunable SFP module. Here, the first notification message comprises at least information on the first channel (and the associated first optical wavelength). The information on the first channel may comprise at least information enabling (unique) identification of the first channel (e.g., the first channel number, the first optical wavelength and/or the first optical frequency). The first notification message may further comprise a first message type identifier identifying the first notification message as a notification and/or cyclic redundancy check information. Additionally or alternatively, the first notification message may comprise one or more pilot bits for indicating a start of a frame.

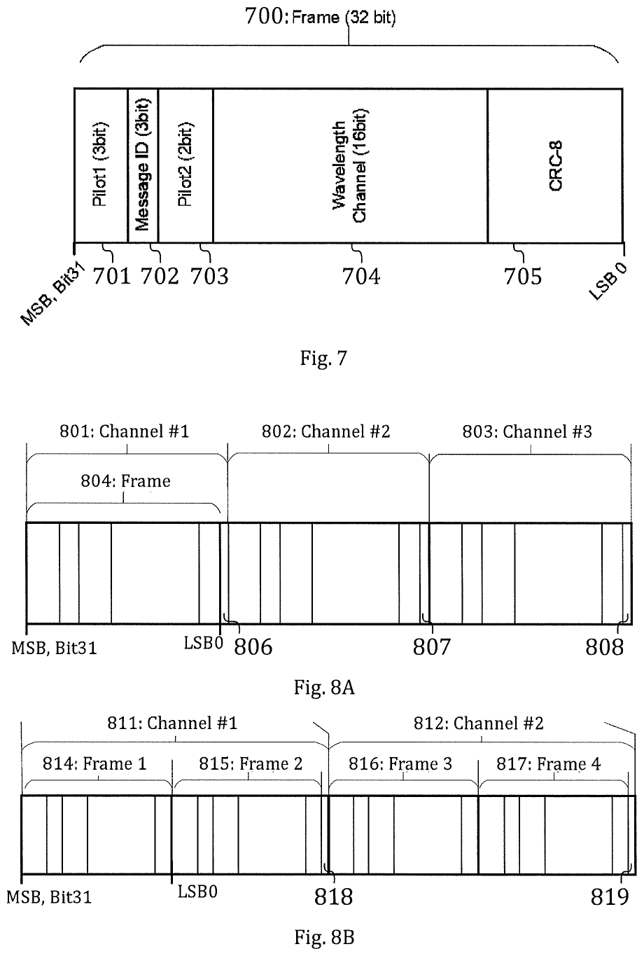

The first notification message may comprise or correspond to a frame (possibly followed by a guard bit). The first notification message may have a pre-defined frame format. In some embodiments, the first notification message 502 may have a pre-defined frame format described in detail below in connection with FIG. 7.

On-off keying is, in general, a simplistic form of amplitude-shift keying (ASK) modulation where digital data is represented as the presence or absence of a carrier wave. In its simplest form, the presence of a carrier for a pre-defined duration (known by the first and second hosts) represents a logical one while its absence for the same pre-defined duration represents a logical zero. Here, the on-off keying is implemented by switching on/off the optical transmitter (or specifically the transmit laser) of the first tunable SFP module.

The second host receives, in block 503, the first notification message via the second tunable SFP module over the OTN from the first host as an on-off keyed transmission (or on-off keyed bitstream).

The second host evaluates (i.e., decodes), in block 504, the first notification message for acquiring the information on the first channel. In reception, the rising edge of the transmitted bit stream may correspond to a switch from a logical zero to a logical one and consequently the falling edge may correspond to a switch from a logical one to a logical zero. The second host may store said information on the first channel to at least one memory of the second host.

The second host transmits, in message 505, a first notification response message via the second tunable SFP module over the OTN on a second channel to the first host by applying on-off keying to an optical transmitter of the second tunable SFP module. The second channel is associated with a second optical wavelength (and a second optical frequency). The first notification response message 505 is transmitted so as to inform the first host that the information on the first channel/wavelength was successfully communicated to the second host. The first notification response comprises at least the information on the first channel. The second channel/wavelength correspond to a transmit channel/wavelength of the second node. The first notification response message may further comprise a second message type identifier identifying the first notification response message as a notification response and/or cyclic redundancy check information. Additionally or alternatively, the first notification response message may comprise one or more pilot bits for indicating a start of a frame. The first notification response message may comprise or correspond to a frame (possibly followed by a guard bit). The first notification response message 505 may have the same pre-defined frame format as the first notification message 502.

In some embodiments, the second channel used for transmission of the first notification response message 505 may be determined based on the information on the first channel (e.g., via a pre-defined mapping between the two channels).

The first host receives, in block 506, the first notification response message via the first tunable SFP module over the OTN from the second host as an on-off keyed transmission on the second channel. The first host evaluates (i.e., decodes), in block 507, the first notification response message for acquiring the information on the first channel (i.e., information that the first channel and the associated first optical wavelength are usable for transmission to the second host). Also here, the rising edge of the transmitted bit stream may correspond to a switch from a logical zero to a logical one and consequently the falling edge may correspond to a switch from a logical one to a logical zero. The first host may store, in response to the evaluating in block 507, said information on the first channel communicated in the first notification response message to at least one memory of the first host.

The transmission of the notification message (message 502) and reception of the first notification response message (in block 506) in FIG. 5A may be carried out using a low-speed (physical) interface of the first tunable SFP module and/or one or more hardware pins of the first tunable SFP module (as described in connection with FIGS. 2, 3 and/or 4).

The reception of the notification message (block 503) and transmission of the first notification response message (in message 505) in FIG. 5A may be carried out using a low-speed (physical) interface of the second tunable SFP module and/or one or more hardware pins of the second tunable SFP module (as described in connection with FIGS. 2, 3 and/or 4).

The signalling shown in FIG. 5A corresponds to a simple scenario where the channel/wavelength selection is completed successfully without any issues. In practice, it is not certain, following the transmission of the first notification message 502, whether or not the first notification message 502 will be successfully received by the second host. The success depends, for example, on the configuration of the OTN. Therefore, the first host may be continuously selecting and configuring new channels/wavelengths and forming and sending out corresponding notification messages (without necessarily stopping to wait for a notification response after each transmitted notification message). For example, the first host may, after and/or before transmitting message 502, repeat the steps relating to elements 501, 502 for one or more further channels (being associated with one or more further wavelengths) before a notification response is successfully received for the first channel or one of the one or more further channels (in block 506). Due to continuous nature of this operation, the first host may not know to which notification message a given received notification response message relates. This is the reason why also the first notification response message 505 in FIG. 5A comprises the information on the first channel (i.e., information for identifying to which notification the notification response relates). Said continuous selecting/configuring of new channels and transmission of notification message on said channels may be stopped only after a notification response message is successfully received (and evaluated).

Following the successful reception/evaluation of the first notification response message in blocks 506, 507, the first host may terminate the channel/wavelength selection procedure for the first channel and configure the first channel/wavelength (for enabling “normal” transmissions on the first channel). The termination may be stateful, that is, the first host may be storing, in at least one memory, all (relevant) channel/wavelength selection related information.

While above, in connection with FIG. 5A, first and second channels were used, respectively, for transmission from the first peer node to the second peer node (or from the first host to the second host) and from the second peer node to the first peer node, in some alternative embodiments, the transmissions from the second peer node to the first peer node may be carried out also on the first channel (i.e., on the same channel which was used for transmissions from the first peer node to the second peer node), instead of the second channel. In other words, both messages 502, 505 may be transmitted on the first channel (using the first optical wavelength). This may be the case, for example, if bidirectional communication is employed (as described below). The procedure of FIG. 5A may be repeated with the roles of the first and second hosts switched so that the first and second hosts are able to acquire information on a second channel/wavelength usable for transmissions from the second host to the first host. This reverse procedure is illustrated in FIG. 5B and discussed in the following only briefly as it is fully analogous with the procedure of FIG. 5A. Any of the definitions provided in connection with FIG. 5A may apply, mutatis mutandis, for the procedure of FIG. 5B.

Similar to FIG. 5A, FIG. 5B illustrates signalling between first and second peer nodes over an OTN. The first and second peer nodes may be assumed to be defined as described in connection with FIGS. 2, 3 and/or 4. Specifically, the actions described in connection with FIG. 5B may be carried out by first and second hosts of the first and second peer nodes in communication with respective first and second tunable SFP modules.

Referring to FIG. 5B, the second host may initially select, in block 511, a second channel for transmission via a second tunable SFP module over the OTN. The second channel is associated with a second optical wavelength (as described also above). The second host also may configure, in block 511, the second tunable SFP to use the second channel for transmission.

The second host transmits, in message 512, a second notification message via the second tunable SFP module over the OTN on the second channel to the first host by applying on-off keying to an optical transmitter of the second tunable SFP module. The second notification message comprises at least information on the second channel.

The first host receives, in block 513, the second notification message via the first tunable SFP module over the OTN from the second host as an on-off keyed transmission on the second channel. The first host evaluates, in block 514, the second notification message for acquiring the information on the second channel and transmits, in message 515, a second notification response message via the first tunable SFP module over the OTN on the first channel to the second host by applying on-off keying to the optical transmitter of the first tunable SFP module. Here, the second notification response message comprises at least the information on the second channel.

The second host receives, in block 516, the second notification response message via the second tunable SFP module over the OTN from the first host as an on-off keyed transmission on the first channel or on a second channel associated with a second optical wavelength. The second notification response message comprises at least the information on the second channel. Finally, the second host evaluates, in block 517, the second notification response message for acquiring the information on the second channel (indicating to the second host that the second channel is usable for transmission to the first host.

Following the successful reception/evaluation of the second notification response message in blocks 516, 517, the second host may terminate the channel/wavelength selection procedure for the second channel and configure the second channel/wavelength (for enabling “normal” transmissions on the second channel). The termination may be stateful, that is, the second host may be storing, in at least one memory, all (relevant) channel/wavelength selection related information.

The processes of FIGS. 5A & 5B may be carried out one after another in any order relative to each other or in parallel.

The processes of FIGS. 5A & 5B may support duplex and/or bidirectional communication. When using duplex communication, both of the first and second hosts (or peer nodes) may carry out the channel/wavelength selection procedure independently and in parallel. In other words, both the first and second nodes may select and configure channels and transmit notification messages at the same time. When using duplex communication, the channels/wavelengths used for transmission may be selected by the first and second host independent of each other. For duplex communication, the first and second hosts (or the first and second nodes) may be triggered upon power-reset.

When using bidirectional communication, one of the first and second peer nodes is configured to act as a primary node (i.e., a transmitting node) and the other as a secondary node (i.e., a receiving or listening node) at any given time. Thus, for bidirectional communication, transmitting operation may be in a halted or suspended state, at any given time, for at least one of the two peer nodes. The primary node is configured to transmit notification message(s) on a transmit channel(s) while the secondary node is configured not to transmit notification messages (or any other messages via the OTN) but only to listen and await reception of notification messages. Once the secondary node has received a valid notification message comprising the information on an associated transmit channel, the secondary node may leave the listener mode by configuring the acquired transmit channel or a channel paired with the acquired transmit channel to the tunable SFP module (i.e., it may start acting as a primary node). Then, this new primary node may transmit a notification response message (comprising the information on the acquired transmit channel) on the configured channel and optionally also start transmitting notification messages and awaiting the corresponding notification response messages. Correspondingly, the previous primary node may start listening for reception of the notification response message as well as any notification messages (i.e., it may start acting as a secondary node). This process may subsequently be repeated for the reverse direction (i.e., the procedure of FIG. 5B may be carried out following the completion of the procedure of FIG. 5A).

As implied in the previous paragraph, bidirectional communication may employ paired channels at the first and second peer nodes so that a first channel assigned for communication from a first peer node to a second peer node (i.e., from a first host to a second host) may determine a second channel assigned to the opposite direction. In other words, each first channel may be mapped to a particular (different) second channel (and vice versa). In other cases, the same channel may be employed for both transmission directions.

The channel/wavelength selection procedures as described above in connection with FIGS. 5A & 5B may be followed by an acknowledgment procedure for acknowledging successful completion of the channel/wavelength selection. The acknowledgment procedure according to embodiments is illustrated in FIG. 6. Namely, FIG. 6 illustrates signalling between first and second peer nodes over an OTN for acknowledging channel/wavelength selection. The illustrated procedure is to a large extent similar/analogous with the channel/wavelength selection of FIGS. 5A & 5B. The first and second peer nodes may be assumed to be defined as described in connection with FIGS. 2, 3 and/or 4. Specifically, the actions described in connection with FIG. 6 may be carried out by first and second hosts of the first and second peer nodes in communication with respective first and second tunable SFP modules.

Referring to FIG. 6, the first and second hosts (or first and second peer nodes) may initially carry out, in block 601, the channel/wavelength selection procedure of FIG. 5A for a first channel and/or the channel/wavelength selection procedure of FIG. 5B for a second channel. It should be emphasized that the first channel may not necessarily be an initial channel for which the first host tried to carry out channel/wavelength selection (i.e., terms “first” and “second” are not meant to imply order here). In other words, the first host may have tried unsuccessfully to select one or more other channels before the first channel.

In response to reception and successful evaluation of the notification response message (and thus selection/configuration of the first channel for transmission), the first host initiates the acknowledgment procedure for the first channel by transmitting, in message 602, a first acknowledgment message via the first tunable SFP module over the OTN on the first channel to the second host by applying on-off keying to the optical transmitter of the first tunable SFP module. The transition into the acknowledgement procedure may be stateful, i.e., the first host may store any channel/wavelength selection related information. The first acknowledgment message comprises at least information on the first channel (i.e., the same information which was included in the notification and notification response messages previously). The first acknowledgment message 602 may further comprise a third message type identifier identifying the first acknowledgment message as an acknowledgment and/or cyclic redundancy check information. Additionally or alternatively, the first acknowledgment message 602 may comprise one or more pilot bits for indicating a start of a frame. The first acknowledgment message 602 may have the same frame format as the notification message (message 502) and the notification response message (message 505).

The second host receives, in block 603, the first acknowledgment message via the second tunable SFP module over the OTN from the first host as an on-off keyed transmission (or on-off keyed bitstream).

The second host evaluates (i.e., decodes), in block 604, the first acknowledgment message for acquiring information that the first channel has been successfully selected (and configured) by the first host.

The second host transmits, in message 605, a first acknowledgment response message via the second tunable SFP module over the OTN on the second channel associated with the second optical wavelength (or, in some embodiments, on the first channel) to the first host by applying on-off keying to the optical transmitter of the second tunable SFP module. The first acknowledgment response message 605 is transmitted so as to inform the first host that the acknowledgment for the first channel/wavelength was successfully communicated to the second host. The acknowledgment response comprises at least the information on the first channel. The first acknowledgment response message may further comprise a fourth message type identifier identifying the first acknowledgment response message as an acknowledgment response and/or cyclic redundancy check information. Additionally or alternatively, the first acknowledgment response message may comprise one or more pilot bits for indicating a start of a frame. The first acknowledgment response message 605 may have the same pre-defined frame format as the first acknowledgment message 602.

The first host receives, in block 606, the first acknowledgment response message via the first tunable SFP module over the OTN from the second host as an on-off keyed transmission on the second channel (or on the first channel). The first acknowledgment response message comprises at least the information on the first channel.

The first host evaluates (i.e., decodes), in block 607, the first acknowledgment response message for acquiring the information on the first channel (i.e., information that the acknowledgment procedure for the first channel and the associated first optical wavelength has been successfully completed).

The transmission of the first acknowledgment message (message 602) and reception of the first acknowledgment response message (in block 606) in FIG. 6 may be carried out using a low-speed (physical) interface of the first tunable SFP module and/or one or more hardware pins of the first tunable SFP module (as described in connection with FIGS. 2, 3 and/or 4).

The reception of the first acknowledgment message (block 603) and transmission of the first acknowledgment response message (in message 605) in FIG. 6 may be carried out using a low-speed (physical) interface of the second tunable SFP module and/or one or more hardware pins of the second tunable SFP module (as described in connection with FIGS. 2, 3 and/or 4).

Following the successful reception/evaluation of the first acknowledgment response message in blocks 606, 607, the first host may terminate the acknowledgment procedure for the first channel and configure the first channel (for enabling “normal” transmissions on the first channel). The termination may be stateful, that is, the first host may be storing, in at least one memory, all channel/wavelength selection related information.

The process described in connection with elements 602 to 607 of FIG. 6 may be repeated with the roles of the first and second hosts switched so that the successful selection (and configuration) of the second channel usable for transmissions from the second host to the first host can also be acknowledged. Any of the definitions provided in connection with blocks 602 to 607 may apply, mutatis mutandis, in this reverse case. The reverse process is discussed only in brief in the following in reference to blocks 608 to 613 as it is fully analogous with the procedure discussed in connection with blocks 602 to 607.

The second host initiates the acknowledgment procedure for the second channel by transmitting, in message 608, a second acknowledgment message via the second tunable SFP module over the OTN on the second channel to the first host by applying on-off keying to the optical transmitter of the second tunable SFP module.

The first host receives, in block 609, the second acknowledgment message via the second tunable SFP module over the OTN from the second host as an on-off keyed transmission (or on-off keyed bitstream).

The first host evaluates (i.e., decodes), in block 610, the second acknowledgment message for acquiring information that the second channel has been successfully selected (and configured) by the second host.

The first host transmits, in message 611, a second acknowledgment response message via the second tunable SFP module over the OTN on the first channel associated with the first optical wavelength (or, in some embodiments, on the second channel) to the second host by applying on-off keying to the optical transmitter of the first tunable SFP module. The first acknowledgment response message 611 is transmitted so as to inform the second host that the acknowledgment for the second channel/wavelength was successfully communicated to the first host.

The second host receives, in block 612, the second acknowledgment response message via the first tunable SFP module over the OTN from the first host as an on-off keyed transmission on the first channel (or on the second channel).

The second host evaluates (i.e., decodes), in block 613, the second acknowledgment response message for acquiring the information on the second channel (i.e., information that the acknowledgment procedure for the second channel and the associated second optical wavelength has been successfully completed).

The process of FIG. 6 may support both duplex and bidirectional communication, similar to as described for channel/wavelength selection of FIGS. 5A and 5B.

The signalling shown in FIGS. 5A, 5B & 6 corresponds to a simple scenario where the channel/wavelength selection & acknowledgment procedures are completed successfully without any issues. Various recovery strategies may be implemented for handling failures so as to avoid a deadlock. One or more of the following properties may apply for the recovery strategy according to embodiments.

The transition into the acknowledgement procedure may be triggered only after a successful completion of channel/wavelength selection procedure (for one or both transmit directions), as described above.

The transition into the acknowledgement procedure may be stateful, i.e., the sending entity (i.e., the first/second host) is storing all wavelength/channel selection related information.

If the acknowledgment procedure fails for any reason, the channel/wavelength selection procedure may be (re)triggered. The acknowledgment procedure may fail, for example, if the first host fails to transmit the acknowledgment message or receive the acknowledgment response message or the second host fails to receive or respond to the acknowledgment message. In any of said failure cases, the host (or peer) detecting the failure may return to the channel/wavelength selection procedure.

After a return to the channel/wavelength selection procedure, the host (or peer) may resume at the last channel used before leaving the channel/wavelength selection procedure (i.e., the last channel using which the channel/wavelength selection procedure was carried out successfully). For this purpose, the peer shall maintain a stateful leave from the channel/wavelength selection procedure.

In some embodiments, a host (or a peer node) may reinitialize (i.e., start from the beginning) the channel/wavelength selection procedure once a pre-defined number or list of different channels/wavelengths has been covered.

In some embodiments, a host (or a peer node) may leave the acknowledgment procedure stateless, i.e., the peer may reuse latest/newest information when (re)entering the acknowledgment procedure. Therefore, there is no need to backup previous/older information.

FIG. 7 illustrates a pre-defined frame format 700 usable by the hosts (or peer nodes in general). Said pre-defined frame format may be used in any messages discussed in connection with FIGS. 5A, 5B and/or 6.

In general, the pre-defined frame format 700 may have at least the following information elements:
at least one pilot information element 701, 703 indicating a start of a frame,
a message type identifier 702 identifying a type of the frame,
a channel information element 704 carrying the information on the channel and
a cyclic redundancy check (CRC) information element 705 for verifying bit errors in the pre-defined frame format.

More specifically and referring, in particular, to the example of FIG. 7, the following definitions (or at least some of them) may apply for the frame 700 and the information elements 701 to 705.

The frame 700 may have be a 32 bit frame. The least significant bit (LSB) may be the bit 0, and the most significant bit (MSB) may be the bit 31. The frames may be transferred in Big-Endian order.

As the sending/receiving of messages in binary format according to embodiments is asynchronous, i.e., there is no synchronization channel that can be used for indicating the start and end of a message, a separate pilot information element 701, 703 indicating the start of the frame is provided in the frame. The pilot information element 701, 703 may have a size of 5 bits. The pilot information element may be fragmented into a first pilot information element 701 (directly) preceding the message type identifier 702 and a second pilot information element 703 (directly) following the message type identifier 702. The pilot information element 701, 703 may be pre-defined and constant. The first pilot information element 701 may have a size of 3 bits while the second pilot information element 703 may have a size of 2 bits.

The message type identifier 702 may have a size of at least 3 bits. Unique message type identifiers may be defined at least for the notification message, the notification response message, the acknowledgment message and the acknowledgment response message.

The channel information element 704 may have a size of 16 bits. This element 704 may comprise, e.g., information on a channel number, an optical wavelength of the channel and/or an optical frequency of the channel. In an embodiment, the channel information element 704 comprises (or consists of) said information on the optical wavelength.

The CRC information element 705 may be, for example, a CRC8 information element. The CRC8 information element 705 may have a size of 8 bits. A first (transmitting) host may calculate the CRC8, append it to the message frame (as shown in FIG. 7) and send this frame out. A second (receiving) host may receive the frame and calculate the CRC8 over the complete frame. The expected CRC8 shall be zero. If the result of the calculation is zero, the frame is bit-error free and valid. If the result of the calculation is non-zero, the frame is not valid (i.e., it contains an error).

In other embodiments, the CRC information element 705 may be a CRC16 or CRC 32 information element.

It should be emphasized that the sizes of the information elements provided above are merely exemplary. Other sizes may be employed in other embodiments. The features described in connection with FIG. 7 are not specific to the sizes described above and indicated in FIG. 7.

As described above, a host (or a peer node) is configured to compile message frames and to sending these towards another host (another peer node) over the OTN. Notification messages may be, in most cases, transmittable without delay though, at some point in time, notification response messages also need to be transmitted. Thus, each host (or peer node) should configure and schedule transmission of frames.

FIGS. 8A and 8B illustrate two examples of clustering of frames according to embodiments. The term “cluster” in this context refers to a set of one or more (consecutive) message frames transmitted using the same channel/wavelength. A cluster may comprise, in general, one or more notification messages and/or one or more notification response messages transmitted consecutively on the same channel. Optionally, a guard bit may be included at the end of the cluster, as will be described below in detail.

FIG. 8A shows three consecutive frames 804 corresponding to (i.e., transmitted on) three different channels 801, 802, 803. Each of the three channels 801, 802, 803 is associated with a different optical wavelength (or equally frequency). Thus, the first (transmitting) host may be configured to select and configure the channel #1 801, transmit a frame 804 on the channel #1 801, select and configure the channel #2 802 (i.e., being the next channel following the channel #1), transmit a frame on the channel #2 802, select and configure the channel #3 803 (i.e., being the next channel following the channel #2) and transmit a frame on the channel #3. The illustrated frames 804 may be 32 bit frames. The three frames may correspond specifically to notification messages.

The first (transmitting) host (or equally the first peer node) may start the channel/wavelength selection procedure at channel #1 801, unless otherwise configured. As described above, the first host may be stateful, i.e., it may perform bookkeeping so as to store all relevant information (e.g., which channel/wavelength is configured, which message type has been sent out and/or which message type has been received). This stateful approach enables returning to the channel/wavelength selection procedure following a failure of the acknowledgment procedure.

Each of the three frames shown in FIG. 8A may correspond to the frame format of FIG. 7. Additionally, a guard bit 806, 807, 808 may be transmitted after the end of the frame on the same channel (as a part of the notification message). The use of guard bits is to be discussed below in detail.

FIG. 8B shows four consecutive frames 814, 815, 816, 817 corresponding to (i.e., transmitted on) two different channels 811, 812. Namely, two consecutive frames 814, 815 (and a guard bit 818) are transmitted on channel #1 811 as a first cluster and the other two consecutive frames 816, 817 (and a guard bit 819) are transmitted on channel #2 812 as a second cluster. In other words, the same transmitting of two notification message frames 814, 816 as in FIG. 8A is shown in FIG. 8B though, here, notification response message frames 815, 817 are appended or injected between the notification message frames 814, 816.

Specifically, the frame 1814 corresponds to a notification message and comprises information a first channel (associated with a first wavelength and being usable for transmission from the first host to the second host over the OTN). The frame 1 814 is transmitted, first, on selected & configured channel #1 811. Then, before continuing with the next channel (i.e., the channel #2 812), the first (transmitting) host (compiles and) further transmits the frame 2 815 comprising information on a second channel (associated with a second wavelength and being usable for transmission from the second host to the first host over the OTN) on the same channel #1 811 as the previous frame 1814. In other words, the frame 1 814 (being a notification message frame) is clustered with the frame 2 815 (being a notification response message frame) to form the first cluster.

Following the transmission of the frames 1 & 2 814, 815 forming (with a guard bit 818) the first cluster, the first (transmitting) host selects and configures the channel #2 812 (being the next channel following the channel #1 811). Then, the first host transmits the frame 3 816 (being a notification message frame) and the frame 4 817 (being a notification response message frame) on the channel #2 812 in a similar manner as described above for the frames 1 & 2 814, 815.

Each of the four frames 814 to 817 shown in FIG. 8B may correspond to the frame format of FIG. 7. Additionally, a guard bit 818, 819 may be transmitted after the end of the last frame of a cluster (i.e., as its least significant bit) on the same channel. The use of guard bits is to be discussed below in detail.

The clustering principle illustrated in FIG. 8B may also be generalized. Namely, in some embodiments, the notification messages and notification responses may be arranged into clusters so that each cluster comprises, in any order, one or more notification messages and one or more notification response messages (and optionally a guard bit at the end). The number of notification message frames per cluster, the number of notification response message frames per cluster and/or the inclusion of a guard bit may be changed on demand.

The clustering principles discussed in connection with FIGS. 8A and 8B for notification message frames and notification response message frames may apply, mutatis mutandis, also for acknowledgment message frames and acknowledgment response message frames. Thus, in the acknowledgment procedure, a cluster may comprise, in general, one or more acknowledgment messages and/or one or more acknowledgment response messages transmitted consecutively on the same channel.

As described in connection with above embodiments, the frame content may be transferred in a format of consecutive transferred bits, i.e., as a bitstream. The bitstream comprises transmitted logical ones and logical zeros. A logical one (i.e., a bit 1) may correspond to the case where an optical transmitter (or equally a laser or a laser diode) of a tunable SFP module is switched on (for a pre-defined amount of time corresponding to a bit duration) while a logical zero (i.e., a bit 0) may refer to the case where the optical transmitter of the tunable SFP module is switched off (for the pre-defined amount of time). On the receiving side, a rising edge of the received signal may correspond to a switch from a logical zero to a logical one and consequently a falling edge of the received signal may correspond to a switch from a logical one to a logical zero.

The bitrate and implicitly the bit duration may be assumed to be constant and known by both peer nodes (i.e., by both hosts). In some embodiments, the bitrate/-duration may be configurable. In such embodiments, both peer nodes need to know the new bitrate/-duration when it is changed.

For the transmit side, the transmitting of the bitstream is relative straightforward. The transmitting peer node (or host) may simply read the bits of a bitstream one-by-one and configure the optical transmitter to switch on/off accordingly.

For a constantly changing bit stream (e.g., 0xAA=10101010) in reception, the correct detection of the bitstream is also a relative straightforward task as each bit corresponds to a rising or falling edge. However, if at least two consecutive bits are received consecutively, the detection is somewhat more complicated due to the fact that received amplitude does not change when the received bit value does not change. In such a case, the receiving peer node (or host) must measure the time between the rising and the falling edge in the bitstream. The measured time must be divided by the bit duration. The outcome of the division is the number of received bits corresponding to a logical zero or one.

However, as the transmission of a logical zero corresponds to transmitting no signal (i.e., the optical transmitter is off), the correct interpretation of a pause in the transmitted bitstream is not straightforward. Namely, lack of signal reception may be interpreted to be caused by one of multiple different valid reasons.

Lack of signal reception may be due to an ongoing transmission of two or more logical zeros. In other words, the receiving peer node (or host) may be still measuring the time to a rising edge (indicating a logical one) following an earlier detection of a falling edge. It should be noted that the rising edge may not be received within the current cluster at the current frequency (N) but, instead, at the next cluster/frequency (N+1). In such a case, the receive side will not even detect the least significant bit of the cluster at the current frequency (N).

To overcome the problem mentioned in the previous paragraph, a so-called guard bit may be introduced to the transmitted clusters. The guard bit has value equal to a logical one XOR'ed with the least significant bit of the bitstream within a given cluster (i.e., 1⊕LSB0). Due to the guard bit, every cluster will be terminated either with a rising edge if the LSB is bit 0 or with a falling edge if the LSB is bit 1. Only after the guard bit has been processed, the transmit side is allowed to switch/change to a new channel (i.e., to a new optical wavelength or frequency). The use of guard bits 806, 807, 808, 818, 819 is shown in FIGS. 8A and 8B for the two clustering examples.

Another reason for a lack of signal reception may be that the transmission of the bitstream has stopped due to a change of the frequency (or equally a change of channel or optical wavelength) at transmit side (i.e., at a transmitting peer node or host). In other words, the receive side (i.e., a receiving peer node or host) may be still measuring the time to a rising edge (indicating a logical one) following an earlier detection of a falling edge, but no rising edge is detected at the appropriate time due to said change of frequency at the transmitting end. In such a case, the receive side may continue measuring the time until a rising edge is detected at the next cluster (corresponding to the next channel/frequency/wavelength N+1), when the transmit side is configured again to a frequency which allows the transfer of the bitstream. The problem at the receiving side is that the receiving peer node or host does not have any knowledge of the unavailability of the transmit path. If the receiving peer node or host calculates the number of consecutively received logical zeros, the calculated number will be very high. Almost all of said logical zeros (all except one which is the LSB of the previous cluster) are, however, false logical zeros resulting from the unavailability of the transmit path.

To overcome the problem described in the previous paragraph, a so-called discard timer may be implemented in the receiving side (i.e., a host of the receiving side). The discard timer may count the time from a falling edge (i.e., a change from 1 to 0) to a pre-defined time limit. When the discard timer expires (i.e., the time matches or exceeds the pre-defined time limit), the receiving side (i.e., the host) discards the measured time. The pre-defined time limit for the discard timer may be n times the bit duration, where n is a positive integer larger than two. For example, n may have a value of 16. Here, the assumption is that, if at least 16 bits having the value 0 are received consecutively, a transmission has been missed (with a high likelihood). The discard timer may be a hardware timer.

The blocks, related functions, and information exchanges (messages) described above by means of FIGS. 5A, 5B and 6 in no absolute chronological order, and some of them may be performed simultaneously or in an order differing from the given one. Other functions can also be executed between them or within them, and other information may be sent, and/or other rules applied. Some of the blocks or part of the blocks or one or more pieces of information can also be left out or replaced by a corresponding block or part of the block or one or more pieces of information.

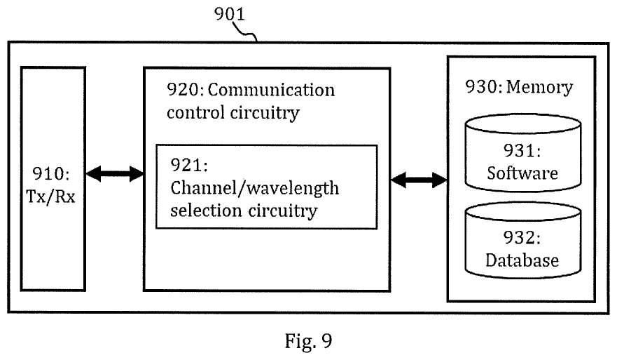

FIG. 9 illustrates an apparatus 901 according to some embodiments. Specifically, FIG. 9 may illustrate an apparatus (or equally a host) 901 for connecting to an OTN via a (tunable) SFP module. The apparatus 901 may form a part of a (remote) radio head or a centralized unit of an access node such as the access node 104 of FIG. 1.

The apparatus 901 may comprise one or more communication control circuitry 920, such as at least one processor, and at least one memory 930, including one or more algorithms 931, such as a computer program code (software) wherein the at least one memory and the computer program code (software) are configured, with the at least one processor, to cause the apparatus to carry out any one of the exemplified functionalities of the apparatus or the (first/second) host described above. Said at least one memory 930 may also comprise at least one database 932.

Referring to FIG. 9, the one or more communication control circuitry 920 of the apparatus 901 comprise at least channel/wavelength selection circuitry 921 which is configured to perform channel/wavelength selection for communication via a (tunable) SFP module and optionally associated acknowledgment functionalities. To this end, the channel/wavelength selection circuitry 921 of the apparatus 901 is configured to carry out at least some of the functionalities of the (first and/or second) host described above, e.g., by means of FIGS. 2 to 4, 5A, 5B, 6, 7, 8A and 8B, using one or more individual circuitries.

Referring to FIG. 9, the memory 930 may be implemented using any suitable data storage technology, such as semiconductor based memory devices, flash memory, magnetic memory devices and systems, optical memory devices and systems, fixed memory and removable memory.

Referring to FIG. 9, the apparatus 901 may further comprise different interfaces 910 such as one or more communication interfaces (TX/RX) comprising hardware and/or software for realizing communication connectivity according to one or more communication protocols. The interfaces 910 may comprise any of the interfaces discussed in connection with any of FIGS. 2 to 4. Specifically, the one or more communication interfaces 910 may comprise, for example, interfaces providing a connection to at least one (tunable) SFP module and/or to an O&M entity. The one or more communication interfaces 910 may enable connecting to the Internet and/or to a core network of a wireless communications network. The one or more communication interface 910 may provide the apparatus with communication capabilities to communicate in a cellular communication system and enable communication to different network nodes or elements (e.g., access nodes or part thereof). The one or more communication interfaces 910 may comprise standard well-known components such as an amplifier, filter, frequency-converter, (de)modulator, and encoder/decoder circuitries, controlled by the corresponding controlling units, and one or more antennas.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory(ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIGS. 2 to 4, 5A, 5B, 6, 7, 8A and 8B may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2 to 4, 5A, 5B, 6, 7, 8A and 8B or operations thereof.

According to an embodiment, there is provided a first apparatus comprising means for:
transmitting a first notification message via a first tunable SFP module over an OTN on a first channel to a second apparatus by applying on-off keying to an optical transmitter of the first tunable SFP module, wherein the first channel is associated with a first optical wavelength and the first notification message comprises at least information on the first channel;
receiving a first notification response message via the first tunable SFP module over the OTN from the second apparatus as an on-off keyed transmission on the first channel or on a second channel associated with a second optical wavelength, wherein the first notification response message comprises at least the information on the first channel; and
evaluating the first notification response message for acquiring the information on the first channel being usable for transmission to the second apparatus.

According to an embodiment, there is provided a second apparatus comprising means for:
receiving a first notification message via a second tunable SFP module over an OTN from a first apparatus as an on-off keyed transmission on a first channel associated with a first optical wavelength, wherein the first notification message comprises at least information on the first channel;
evaluating the first notification message for acquiring the information on the first channel;
transmitting a first notification response message via the second tunable SFP module over the OTN on the first channel or on a second channel associated with a second optical wavelength to the first apparatus by applying on-off keying to an optical transmitter of the second tunable SFP module, wherein the second notification response message comprises at least the information on the first channel.

Embodiments as described may also be carried out in the form of a computer process defined by a computer program or portions thereof. Embodiments of the methods described in connection with FIGS. 2 to 4, 5A, 5B, 6, 7, 8A and 8B may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A first apparatus, comprising:
at least one processor; and
at least one non-transitory memory storing instructions that, when executed with the at least one processor, cause the first apparatus at least to perform:
transmitting a first notification message with a first tunable small-form factor pluggable module connected to the first apparatus and over an optical transport network on a first channel to a second apparatus with applying on-off keying to an optical transmitter of the first tunable small-form pluggable module, wherein the first channel is associated with a first optical wavelength, the first notification message comprises at least information on the first channel and the applying of the on-off keying is performed using one or more hardware pins of the first tunable small-form pluggable module;
receiving a first notification response message with the first tunable small-form pluggable module over the optical transport network from the second apparatus as an on-off keyed transmission on the first channel or on a second channel associated with a second optical wavelength, wherein the first notification response message comprises at least the information on the first channel and the receiving of the first notification response message is performed using one or more hardware pins of the first tunable small-form pluggable module; and
evaluating the first notification response message for acquiring the information on the first channel being usable for transmission to the second apparatus.

2. The first apparatus according to claim 3, wherein the instructions, when executed with the at least one processor, cause the first apparatus to perform, before the transmitting of the first notification message:
selecting the first channel for transmission with the first tunable small-form pluggable module over the optical transport network; and
configuring the first tunable small-form pluggable module to use the first channel for transmission.

3. The first apparatus according to claim 1, wherein the first notification message further comprises a first message type identifier identifying the first notification message as a notification and the first notification response message further comprises a second message type identifier identifying the first notification response message as a notification response.

4. The first apparatus according to claim 1, wherein the first notification message and the first notification response message comprise one or more frames having a pre-defined frame format having at least the following information elements:
at least one pilot information element indicating a start of a frame,
a message type identifier identifying a type of the frame,
a channel information element carrying the information on the first channel, and
a cyclic redundancy check information element.

5. The first apparatus according to claim 4, wherein the first notification message comprises at least one of:
a first guard bit following the least significant bit of a last frame of the first notification message, the first guard bit having a value equal to logical one forming an exclusive disjunction with a least significant bit of the last frame of the first notification message; or
the first notification response message comprises a second guard bit following the least significant bit of a last frame of the first notification response message, the second guard bit having a value equal to logical one forming the exclusive disjunction with the least significant bit of the last frame of the first notification response message.

6. (canceled)

7. The first apparatus according to claim 1, wherein the instructions, when executed with the at least one processor, cause the first apparatus to further perform: implementing a discard timer for discarding any transmissions detected to comprise at least a pre-defined number of consecutive logical zeros, wherein a logical zero, in the on-off keying, corresponds to an absence of a carrier wave for a pre-defined amount of time.

8. The first apparatus according to claim 1, wherein the instructions, when executed with the at least one processor, cause the first apparatus to further perform:
transmitting, in response to the receiving of the first notification response message, an acknowledgment message with the first tunable small-form pluggable module over the optical transport network on the first channel to the second apparatus with applying on-off keying to the optical transmitter of the first tunable small-form pluggable module, wherein the acknowledgment message comprises at least information on the first channel; and
receiving an acknowledgment response message with the first tunable small-form pluggable module over the optical transport network from the second apparatus as an on-off keyed transmission on the second channel, wherein the acknowledgment response message comprises at least the information on the first channel; and
evaluating the acknowledgment response message for acquiring the information on the first channel.

9. The first apparatus according to claim 8, wherein the acknowledgment message further comprises a third message type identifier identifying the acknowledgment message as an acknowledgment and the acknowledge response message further comprises a fourth message type identifier identifying the acknowledge response message as an acknowledge response.

10. The first apparatus according to claim 1, wherein the instructions, when executed with the at least one processor, cause the first apparatus at least to perform: storing, following the evaluating of the first notification response message, said information on the first channel to the at least one memory.

11. The first apparatus according to claim 1, wherein the instructions, when executed with the at least one processor, cause the first apparatus to further perform:
receiving a second notification message with the first tunable small-form pluggable module over the optical transport network from the second apparatus as an on-off keyed transmission on the second channel associated with the second optical wavelength, wherein the second notification message comprises at least information on the second channel;
evaluating the second notification message for acquiring the information on the second channel; and
transmitting a second notification response message with the first tunable small-form pluggable module over the optical transport module on the first channel to the second apparatus with applying on-off keying to the optical transmitter of the first tunable small-form pluggable module, wherein the second notification response message comprises at least the information on the second channel.

12. The first apparatus according to claim 11, wherein the instructions, when executed with the at least one processor, cause the first apparatus to perform the transmitting of the first notification message and of the second notification response consecutively in any order as a part of cluster associated with the first channel, the cluster further comprising a guard bit at its end, the guard bit having a value equal to logical one forming an exclusive disjunction with a least significant bit of the last frame of the cluster.

13. A second apparatus, comprising:
at least one processor; and
at least one non-transitory memory storing instructions that, when executed with the at least one processor, cause the second apparatus at least to perform:
receiving a first notification message with a second tunable small-form pluggable module connected to the second apparatus over an optical transport network from a first apparatus as an on-off keyed transmission on a first channel associated with a first optical wavelength, wherein the first notification message comprises at least information on the first channel and the receiving of the first notification message is performed using one or more hardware pins of the second tunable small-form pluggable module;
evaluating the first notification message for acquiring the information on the first channel; and
transmitting a first notification response message with the second tunable small-form pluggable module over the optical transport network on the first channel or on a second channel associated with a second optical wavelength to the first apparatus with applying on-off keying to an optical transmitter of the second tunable small-form pluggable module, wherein the first notification response message comprises at least the information on the first channel and the applying of the on-off keying is performed using one or more hardware pins of the second tunable small-form pluggable module.

14. A method, comprising:
transmitting a first notification message with a first tunable small-form pluggable module over an optical transport network on a first channel to a second apparatus with applying on-off keying to an optical transmitter of the first tunable small-form pluggable module, wherein the first channel is associated with a first optical wavelength, the first notification message comprises at least information on the first channel and the applying of the on-off keying is performed using one or more hardware pins of the first tunable small-form pluggable module;
receiving a first notification response message with the first tunable small-form pluggable module over the optical transport network from the second apparatus as an on-off keyed transmission on the first channel or on a second channel associated with a second optical wavelength, wherein the first notification response message comprises at least the information on the first channel and the receiving of the first notification response message is performed using one or more hardware pins of the first tunable small-form pluggable module; and
evaluating the first notification response message for acquiring the information on the first channel being usable for transmission to the second apparatus.

15. A non-transitory computer readable medium encoded with a computer program for causing an apparatus to perform:
transmitting a first notification message with a first tunable small-form pluggable module connected to the apparatus and over an optical transport network on a first channel to a second apparatus with applying on-off keying to an optical transmitter of the first tunable small-form pluggable module, wherein the first channel is associated with a first optical wavelength and the first notification message comprises at least information on the first channel and the applying of the on-off keying is performed using one or more hardware pins of the first tunable small-form pluggable module;
receiving a first notification response message with the first tunable small-form pluggable module over the optical transport network from the second apparatus as an on-off keyed transmission on the first channel or on a second channel associated with a second optical wavelength, wherein the first notification response message comprises at least the information on the first channel and the receiving of the first notification response message is performed using one or more hardware pins of the first tunable small-form pluggable module; and
evaluating the first notification response message for acquiring the information on the first channel being usable for transmission to the second apparatus.

16. A method, comprising:
receiving a first notification message with a second tunable small-form pluggable module over an optical transport network from a first apparatus as an on-off keyed transmission on a first channel associated with a first optical wavelength, wherein the first notification message comprises at least information on the first channel and the receiving of the first notification message is performed using one or more hardware pins of the second tunable small-form pluggable module;
evaluating the first notification message for acquiring the information on the first channel; and
transmitting a first notification response message with the second tunable small-form pluggable module over the optical transport network on the first channel or on a second channel associated with a second optical wavelength to the first apparatus with applying on-off keying to an optical transmitter of the second tunable small-form pluggable module, wherein the first notification response message comprises at least the information on the first channel and the applying of the on-off keying is performed using one or more hardware pins of the second tunable small-form pluggable module.

17. A non-transitory computer readable medium encoded with a computer program for causing an apparatus to perform:
receiving a first notification message with a second tunable small-form pluggable module connected to the apparatus and over an optical transport network from a first apparatus as an on-off keyed transmission on a first channel associated with a first optical wavelength, wherein the first notification message comprises at least information on the first channel and the receiving of the first notification message is performed using one or more hardware pins of the second tunable small-form pluggable module;
evaluating the first notification message for acquiring the information on the first channel; and
transmitting a first notification response message with the second tunable small-form pluggable module over the optical transport network on the first channel or on a second channel associated with a second optical wavelength to the first apparatus with applying on-off keying to an optical transmitter of the second tunable small-form pluggable module, wherein the first notification response message comprises at least the information on the first channel and the applying of the on-off keying is performed using one or more hardware pins of the second tunable small-form pluggable module.
